(19) United States
(12) Patent Application Publication
(10) Pub. No.: US 2014/0290080 A1
(43) Pub. Date: Oct. 2, 2014

(54) Combination Square With Biased Locking Mechanism

(71) Applicant: Johnson Level & Tool Mfg. Co., Inc., Mequon, WI (US)

(72) Inventors: Paul H. Buzzell, Mequon, WI (US); John Dwyer, Waukesha, WI (US); William G. Johnson, Mequon, WI (US); Robert A. Johnson, Mequon, WI (US); Glenn T. Walters, Port Washington, WI (US)

(73) Assignee: Johnson Level & Tool Mfg. Co., Inc., Mequon, WI (US)

(21) Appl. No.: 14/227,059

(22) Filed: Mar. 27, 2014

Related U.S. Application Data
(60) Provisional application No. 61/807,583, filed on Apr. 2, 2013.

(51) Int. Cl. G01B 3/56

(52) U.S. Cl. CPC G01B 3/566
USPC 33/469

(57) ABSTRACT

An adjustable combination square includes a longitudinally extending blade slidably received within a slot in a head. A movable clamping member is engaged with the blade, and a biasing member acts on the clamping member to normally bias the clamping member toward an engaged position in which the blade is engaged against a surface of the slot. A manually operable pivotable actuator arrangement is carried by the head. Actuation of the pivotable actuator arrangement applies a force to the clamping member that works against the biasing member so as to selectively move the clamping member away from the engaged position to enable the blade to be moved axially relative to the head. Releasing the pivotable actuator arrangement releases the force so that the biasing member returns the clamping member to the engaged position to maintain the blade in position relative to the head.

### CROSS REFERENCE TO RELATED APPLICATION

This application claims priority from U.S. Provisional Patent Application No. 61/807,583, which was filed on Apr. 2, 2013, the subject matter of which is incorporated by reference in its entirety.

### FIELD OF THE INVENTION

This invention relates to a tool such as an adjustable square, and more particularly to an adjustable combination square.

### BACKGROUND OF THE INVENTION

An adjustable square, such as a combination square, generally includes a longitudinally extending blade that is adjustably coupled to a head. The blade is typically a ruled blade having a straightedge extending along its longitudinal axis. The blade is typically graduated with indicia that mark incremental distances such inches, centimeters and/or millimeters, to assist a user in making measurements. The head includes a channel or slot within which the blade is slidably received. The combination square is used by setting the blade at any desired position relative to the head, which allows a user to make accurate measurements or markings, setting angles, determining flatness, and leveling surfaces when working with various materials such as wood, metal and stone.

In a known construction, the blade includes an axially extending groove, and can be selectively fixed in position relative to the head by a threaded member, i.e. bolt that extends through a passage in the head and that is threadedly engaged with a threaded actuator rotatably secured to the head. The bolt includes an engagement tab at its outer end that is engaged within the groove of the blade, and rotation of the threaded actuator causes axial inward and outward movement of the bolt relative to the head. With this arrangement, rotation of the threaded actuator in one direction causes axial inward movement of the bolt, which draws the engagement tab inwardly to clamp the blade against with the inner surface of the channel or slot in the head, to frictionally retain the blade in a desired position. When the actuator is rotated in the opposite direction, the bolt is caused to move axially outwardly, such that the engagement tab moves the blade away from the inner surface of the channel or slot in the head. The axial position of the blade relative to the head can then be adjusted, with the engagement tab of the bolt remaining in engagement with the groove in the blade so as to allow movement of the blade while maintaining the blade in engagement with the head.

A combination square of the type described generally requires the use of two hands to operate the locking mechanism—one to grasp the head and the other to rotate the threaded actuator. In addition, the need to rotate the threaded actuator results in a twisting motion that must be countered by the user when maintaining the blade in a desired position relative to the head during rotation of the actuator. It can thus be appreciated that this type of locking mechanism is somewhat cumbersome and inefficient.

It is an object of the present invention to provide an adjustable square that has an improved locking mechanism that eliminates the need for a threaded actuator. It is another object of the invention to provide a locking mechanism for an adjustable square that is easy to actuate while providing sufficient engagement force between the head and blade to maintain the blade in a desired position relative to the head. A further object of the present invention is to provide an adjustable square with a locking mechanism that is ergonomically advantageous in that provides quick and easy engagement and release of the blade relative to the head.

In accordance with one aspect of the invention, an adjustable square includes a blade extending along a longitudinal axis and having an axially extending engagement structure, and a head having a slot within which the longitudinally extending blade is received. The head includes a movable clamping member engaged with the axially extending engagement structure of the blade. A biasing member acts on the movable clamping member so as to bias the clamping member toward an engaged position in which the blade is engaged against a surface of the slot. A manually operable pivotable actuator arrangement is carried by the head. Actuation of the pivotable actuator arrangement applies a force to the clamping member that works against the biasing member so as to selectively move the clamping member away from the engaged position to enable the blade to be moved axially relative to the head. Releasing the pivotable actuator arrangement functions to release the force so that the biasing member returns the clamping member to the engaged position so as to maintain the blade in position relative to the head. The pivotable actuator arrangement may be movable about a pivot axis that is oriented perpendicular to the direction of the force applied by the clamping member on the blade, which in a first embodiment may be perpendicular to the longitudinal axis of the blade and in a second embodiment may be parallel to the longitudinal axis of the blade.

The biasing member may he in the form of a spring that acts on the movable clamping member so as to bias the clamping member toward the surface of the slot.

In the first embodiment, the manually operable pivotable actuator arrangement is in the form of a pivotable trigger member secured to the head for movement about a pivot axis perpendicular to the longitudinal axis of the blade between an engaged position and a release position. The biasing member normally biases the trigger member toward the engaged position, and manual actuation of the pivotable trigger member moves the pivotable trigger member to the release position against the force of the biasing member. The trigger member includes an actuator section secured to the head via a pivot connection, and a finger engagement section that extends from the actuator section and arranged such that application of a manual force to the finger engagement section causes pivoting movement of the actuator section. The actuator section includes clamping member engagement structure that causes movement of the clamping member away from the engaged position upon pivoting movement of the pivotable trigger member to the release position.

In the second embodiment, the manually operable pivotable actuator as a arrangement is in the form of a pivotable actuator tab secured to the head for movement about a pivot axis parallel to the longitudinal axis of the blade between an engaged position and a release position. The biasing member normally biases the pivotable actuator tab toward the engaged position, and manual actuation of the pivotable actuator tab moves the pivotable actuator tab to the release position against the force of the biasing member. Representatively, the pivotable actuator arrangement may be in the form of a pair of pivotable actuator tabs that are pivotable about a common pivot axis toward and away from each other between the engaged and disengaged positions. The biasing member may be in the form of a spring interposed between the pair of pivotable actuator tabs, which applies a biasing force on the pivotable actuator tabs that urges the pivotable actuator tabs to the engaged position. The pivotable actuator tab may include an actuator section secured to the head via a pivot connection, and a finger engagement section that extends from the actuator section. Application of a manual force to the finger engagement section causes linear movement of the actuator section. The actuator section includes clamping member engagement structure that causes linear movement of the clamping member away from the engaged position upon pivoting movement of the pivotable actuator tab to the release position.

In accordance with another aspect of the invention, a method of operating an adjustable square that includes a head having a slot within which a longitudinally extending blade is slidably received includes normally urging the blade against a surface of the slot via a biasing force to frictionally maintain the blade in position relative to the head; moving the blade out of engagement with the surface of the slot against the biasing force by manual movement of a manually operable pivotable actuator arrangement to a release position; adjusting the position of the blade relative to the head while maintaining the manually operable pivotable actuator arrangement in the release position; and releasing the manually operable pivotable actuator arrangement to enable the blade to engage the surface of the slot under the influence of the biasing force and maintain the blade in position relative to the head. The act of normally urging the blade against the surface of the slot is carried out via a movable clamping member engaged with axially extending engagement structure of the blade, and the act of moving the blade out of engagement with the surface of the slot is carried out by moving the movable clamping member by operation of the manually operable pivotable actuator arrangement. The act of normally urging the blade against the surface of the slot may be carried out by application of the biasing force to the clamping member. In one embodiment, the act of moving the blade out of engagement, with the surface of the slot is carried out by manually pivoting the pivotable actuator arrangement about a pivot axis oriented perpendicular to the longitudinal axis of the blade. In another embodiment, the act of moving the blade out of engagement with the surface of the slot is carried out by manually pivoting the pivotable actuator arrangement about a pivot axis oriented parallel to the longitudinal axis of the blade.

These and other features, objects and advantages of the present invention will be made apparent from the following description taken together with the drawings.

### BRIEF DESCRIPTION OF THE DRAWINGS

Exemplary embodiments of the invention are illustrated in the accompanying drawings in which like reference numerals represent like parts throughout.

In the drawings:

FIG. 1 is an isometric view of an adjustable square incorporating a trigger-type locking mechanism in accordance with a first embodiment of the present invention;

FIG. 2 is an exploded isometric view illustrating the adjustable square and trigger-type locking mechanism of FIG. 1;

FIG. 3A is a partial isometric view of the adjustable square and trigger-type locking mechanism of FIG. 1, with portions removed;

FIG. 3B is a partial isometric view of the adjustable square and trigger-type locking mechanism similar to FIG. 3A, with additional portions removed;

FIG. 4A is a partial isometric view of the adjustable square and trigger-type locking mechanism shown in FIG. 1, showing the trigger-type locking mechanism in an engaged position in which the blade is clamped against the head for maintaining the blade in position;

FIG. 4B is a partial isometric view similar to FIG. 4A, showing the trigger-type locking mechanism in a release position to allow the blade to be axially moved relative to the head;

FIG. 4C is a partial elevation view illustrating the adjustable square and internal components of the trigger-type locking mechanism when the trigger-type locking mechanism is in the engaged position of FIG. 4A;

FIG. 4D is a partial elevation view similar to FIG. 4C illustrating the internal components of the trigger-type locking mechanism when the trigger-type locking mechanism is in the release position of FIG. 4B;

FIG. 5 is an isometric view of an adjustable square incorporating a squeeze tab-type locking mechanism in accordance with a second embodiment of the present invention;

FIG. 6 is an exploded isometric view illustrating the adjustable square and squeeze tab-type locking mechanism of FIG. 5;

FIG. 7A is a partial isometric view of the adjustable square and squeeze tab-type locking mechanism of FIG. 5, with portions removed;

FIG. 7B is a partial isometric view of the adjustable square and squeeze tab-type locking mechanism similar to FIG. 7A, with additional portions removed;

FIG. 8A is a section view taken along line 8-8 of FIG. 5, showing the locking mechanism in an engaged position in which the blade is clamped against the head for maintaining the blade in position; and

FIG. 8B is a section view similar to FIG. 8A, showing the squeeze tab-type locking mechanism in a release position to allow the blade to be axially moved relative to the head.

In describing the exemplary embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

Specific embodiments of the present invention will be described by the following non-limiting examples which will serve to illustrate various features of the invention.

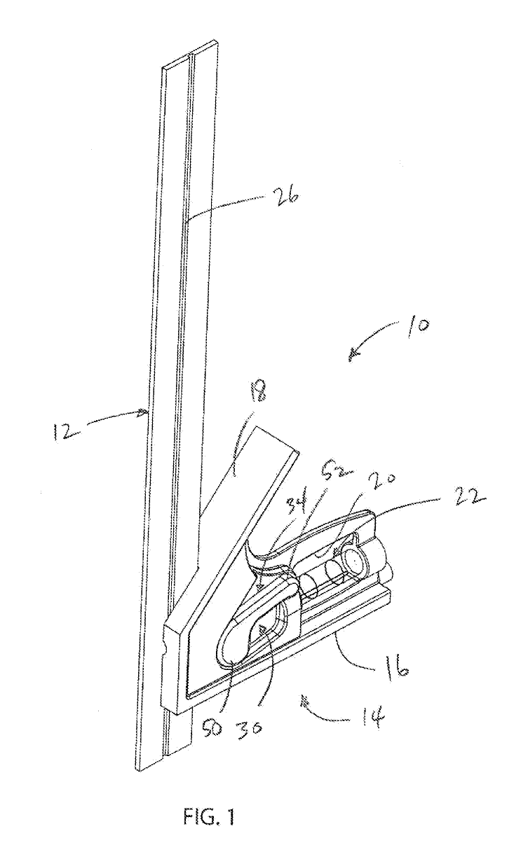

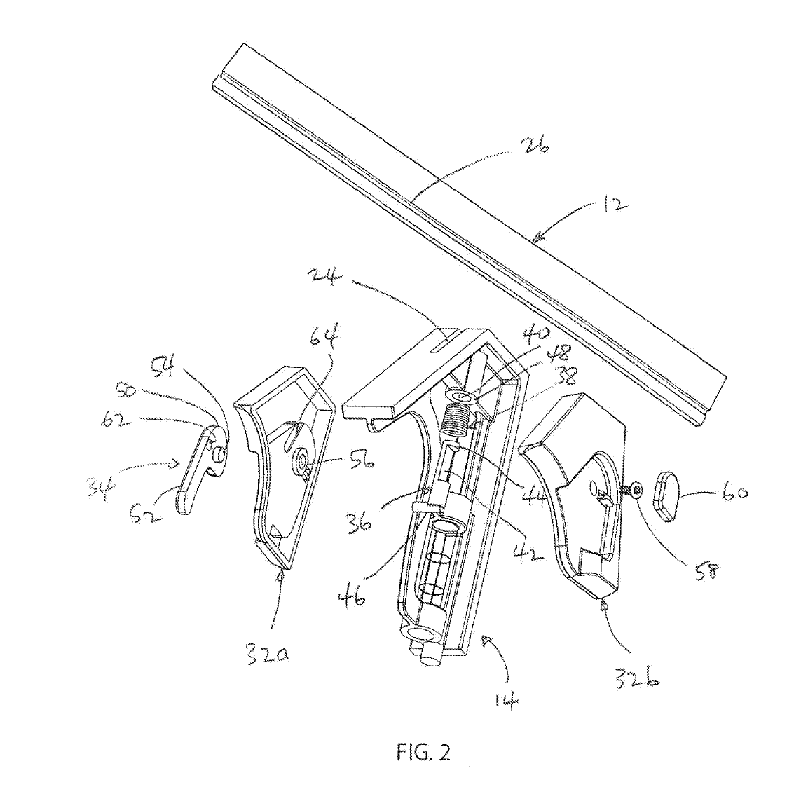

FIGS. 1-4D illustrate a first embodiment of an adjustable square 10 in accordance with the present invention. Generally, adjustable square 10 includes a blade 12, which extends along a longitudinal axis and is slidably mounted to a head 14. In a manner as is known, the head 14 includes a first gauging surface 16 and a second gauging surface 18. Gauging surface 16 is oriented perpendicular to the longitudinal axis of blade 12 and gauging surface 18 is oriented at an angle of 45° to the longitudinal axis of blade 12. Also as is known, head 14 may optionally be constructed to have a window 20 within which a level vial 22 is mounted. Head 14 includes a channel or slot 24 (FIG. 2) within which blade 12 is slidably received.

Blade 12 includes a longitudinally extending channel or groove 26 that extends longitudinally throughout its length. In a manner to be explained, groove 26 provides a guide for movement of blade 12 relative to head 14 and is also employed to selectively secure blade 12 in a position relative to head 14. Blade 12 may be constructed from a single piece of extruded metal such as, for example, aluminum or steel, and stamped or printed with measurement graduations (not shown) along one or both faces of blade 12.

A biased trigger-type actuator mechanism in accordance with the present invention, shown generally at 30 in FIG. 1, is employed to selectively secure blade 12 in a desired position relative to head 14. Referring to FIGS. 1 and 2, trigger-type actuator mechanism 30 includes a pair of cover members 32a and 32b, which are mounted one on either side of head 14. In addition, actuator mechanism 30 generally includes a pivoting trigger member 34 that pivots about an axis perpendicular to the longitudinal axis of blade 12, a clamping member in the form of a post 36, and a spring 38, which cooperate in a manner to be explained to selectively secure blade 12 in a desired position relative to head 14. As shown in FIG. 2, post 36 has a generally circular cross-section and is adapted to be received within a passage 40 defined by head 14. In a manner as is known, passage 40 is in communication with slot 24. Post 36 is formed with a recess 42, and defines an engagement tab 44 at its upper end. When the post 36 is inserted into passage 40, engagement tab 44 is positioned above the bottom surface of slot 24. In this manner, engagement tab 44 is received within groove 26 in blade 12 when blade 12 is inserted into slot 24.

At its lower end, post 36 is engaged with an actuator pin 46. When post 36 is inserted into passage 40, it extends through the passage defined by spring 38. Spring 38 thus bears between actuator pin 46 and the peripheral surface at the entrance of passage 40, shown at 48, to bias post 36 downwardly, i.e. in a direction that tends to force engagement tab 44 toward the bottom surface of slot 24. While spring 38 is illustrated as a coil-type spring, it should be appreciated that any other type of spring biasing arrangement may be employed, such as a torsion-type spring, a leaf spring, etc.

Trigger member 34 generally includes an actuator section 50 and a finger engagement section 52. The actuator section 50 is formed with a protrusion 54, which is configured to extend through a mating opening 56 in cover member 32a so as to pivotably mount trigger member 34 to cover member 32a. The protrusion 54 may include an axial passage, and a screw 58 may be received within the axial passage of protrusion 54 so as to pivotably maintain trigger member 34 into engagement with cover member 32a. If desired, a screw cover 60 may be mounted to cover section 32b to conceal the head of screw 58.

Actuator section 50 of trigger member 34 includes an aperture 62 extending from its inner surface and laterally offset from protrusion 54. Cover member 32a includes a slot 64 that is aligned with aperture 62. Actuator pin 46 extends through slot 64 and is received within aperture 62. In this manner, actuator pin 46 is engaged with trigger member 34 at a location offset from the pivot axis of trigger member 34 defined by protrusion 54.

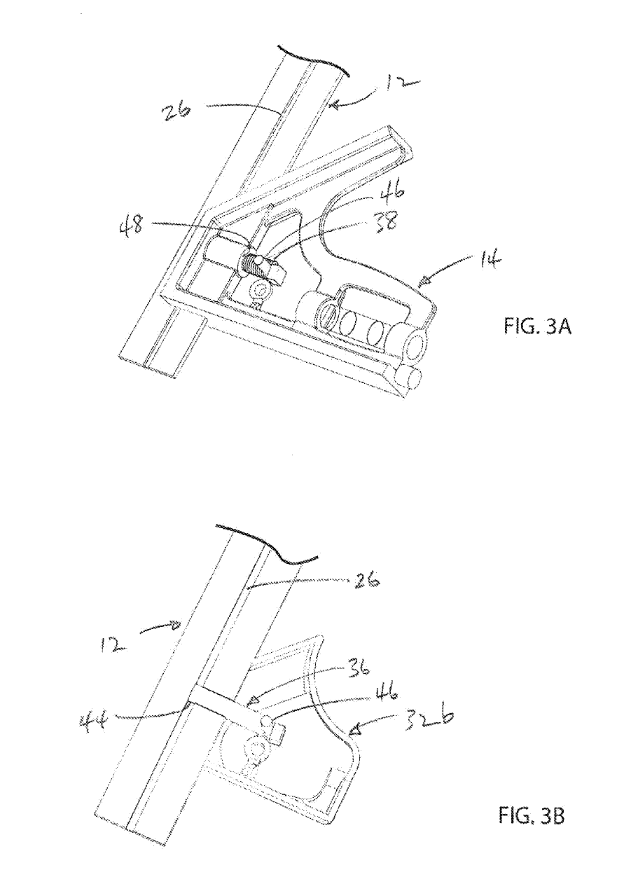

FIG. 3A shows the components of actuator mechanism 30 with cover member 32a and trigger member 34 removed. As illustrated, spring 38, actuator pin 46 and the lower end of post 36 are positioned within a void internal area defined by head 14. Post 36 is shown as extending through the central passage of spring 38, with spring 38 functioning to bear between surface 48 and actuator pin 46 so as to urge post 36 in a downward direction. FIG. 3B is a somewhat similar representation but with head 14 removed. In this view, engagement tab 44 of post 36 is illustrated as being positioned within groove 26 of blade 12 for both maintaining engagement of blade 12 with head 14 and guiding longitudinal movement of blade 12 relative to head 14.

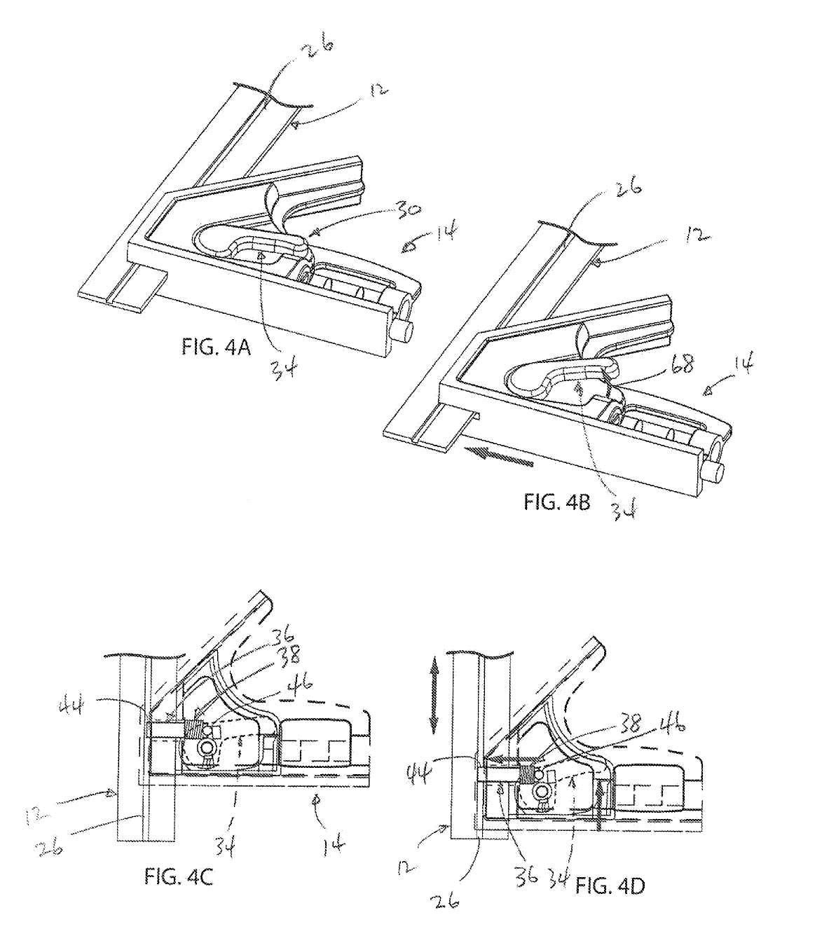

Operation of trigger-type actuator mechanism 30 is illustrated in FIGS. 4A-4D. Generally, trigger member 34 is movable between an engaged, at-rest position as shown in FIG. 4A and a release position as shown in FIG. 4B.

As shown in FIG. 4C, when trigger member 30 is in the engaged, at-rest position of FIG. 4A, the spring 38 is extended so as to urge actuator pin 46 outwardly. This functions to draw post 36 downwardly, to urge the bottom edge of blade 12 against the bottom surface of slot 24 in body 14. This causes frictional clamping engagement of blade 12 with body 14 to prevent axial movement of blade 12. The downward bias of actuator pin 46 also functions to urge trigger member 34 to its at-rest position as shown in FIG. 4A. Suitable stop structure may be interposed between trigger member 34 and cover member 32a to maintain trigger member 34 in the at-rest position, if desired.

In order to provide movement of blade 12 relative to head 14, the user engages trigger member 30 at finger engagement section 52 and applies a force that moves trigger member 34 away from the at-rest position of FIG. 4A to the release position of FIG. 4b, in the direction of arrow 68. Such pivoting movement of trigger member 34 causes upward movement of actuator pin 46 toward blade 12. which compresses spring 38 against surface 48. Due to engagement of engagement tab 44 within groove 26 of blade 12, this functions to lift the lower edge of blade 12 away from the bottom surface of slot 24, to release frictional engagement of blade 12 with head 14. The user can then slide blade 12 relative to head 14 to a desired axial position along the length of blade 12. When the desired position of blade 12 is attained, the user releases engagement of finger engagement section 52 of trigger member 34. This functions to release the compressive force on spring 38, such that spring 38 returns to its extended condition to return trigger member 34 to its at-rest position and cause the lower edge of blade 12 to again come into frictional engagement with the lower surface of slot 24 and maintain the relative position of blade 12 and head 14, as described above. It can thus he appreciated that trigger-type actuator mechanism 30 provides an arrangement in which blade 12 and head 14 are normally frictionally engaged. Release of frictional engagement between blade 12 and head 14 can be accomplished with one hand by application of a simple pivoting force on trigger member 34, with the act of restoring engagement between blade 12 and head 14 being accomplished by simply releasing manual pressure on trigger member 34.

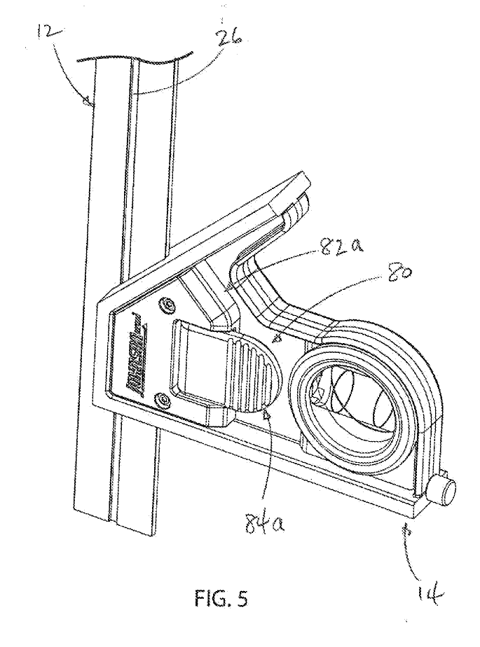

FIGS. 5-8B illustrate another embodiment of the adjustable square 10 in accordance with the present invention. Like reference characters will be used where possible to facilitate clarity. In this embodiment, a squeeze-type actuator mechanism 80 is employed to selectively release engagement of blade 12 with head 14.

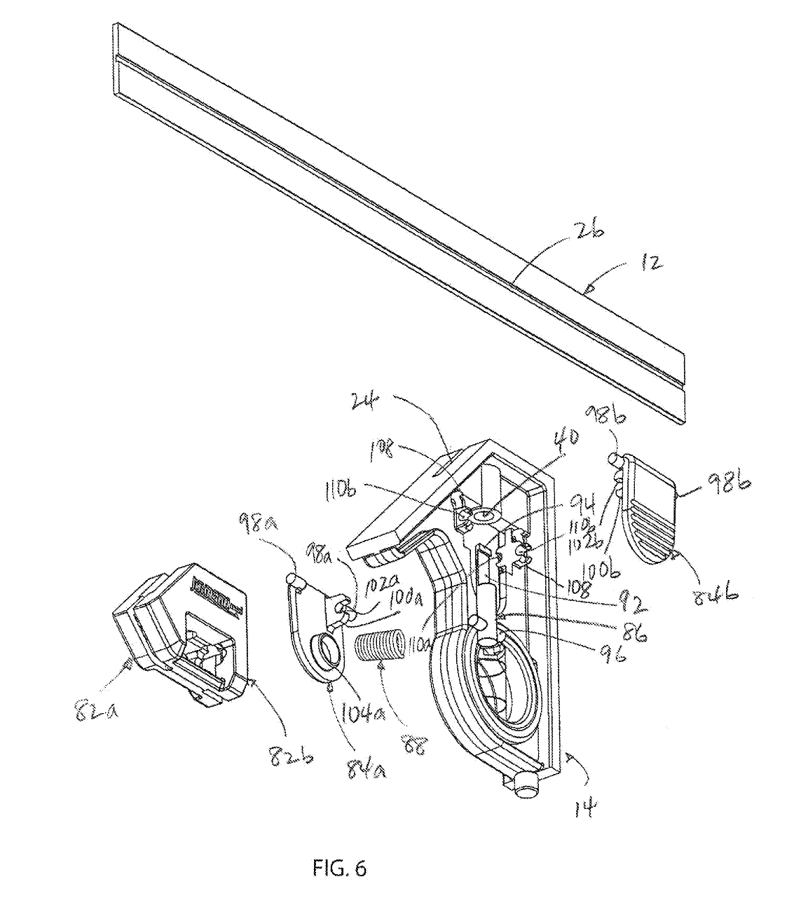

As shown in FIG. 6, squeeze-type actuator mechanism 80 generally includes a pair of cover members 82a and 82b, which are mounted one on either side of head 14. In addition, actuator mechanism 80 generally includes a pair pivoting squeeze tabs 84a, 84b that pivot about a pivot axis parallel to the axis of blade 12. a clamping member in the form of a post 86, and a spring 88. which cooperate in a manner to be explained to selectively secure blade 12 in a desired position relative to head 14.

As shown in FIG. 6, post 36 has a generally circular cross-section and is adapted to be received within passage 40 defined by head 14. As described above, passage 40 is in communication with slot 24. Post 86 is formed with a recess 92, and defines an engagement tab 94 at its upper end. When the post 86 is inserted into passage 40, engagement tab 94 is positioned above the bottom surface of slot 24. In this manner, engagement tab 44 is received within groove 26 in blade 12 when blade 12 is inserted into slot 24. At its lower end, post 86 is engaged with an actuator pin 96, which extends outwardly from each side of post 86.

The squeeze tabs 84a and 84b are similarly constructed. Squeeze tabs 84a and 84b have upper laterally extending pivot pins 98a and 98b, respectively, at their upper ends. In addition, squeeze tabs 84a and 84h include respective inwardly extending actuator cradles 100a, 100b, which define respective recesses 102a, 102b. Squeeze tabs 84a and 84b also include respective spring receivers 104a and 104b, within which the ends of spring 88 are received. While spring 88 is illustrated as a coil-type spring, it should be appreciated that any other type of spring biasing arrangement may be employed, such as a torsion-type spring. a leaf spring, etc.

In this embodiment, body 14 is formed to include spaced apart pivot cradles 108 defining oppositely facing pivot recesses 110a, 110b. In assembly, the pivot pins 98a are engaged with pivot recesses 110a and pivot pins 98b are engaged with pivot recesses 110b. Cover members 82a, 82b are positioned over pivot pins 98a, 98b, respectively, so as to maintain pivot pins 98a and 98b within the pivot recesses 110a. 110b. Spring 38 is operable to bias the lower ends of squeeze tabs 84a, 84b apart from each other. Also in assembly, the ends of actuator pin 96 are received within actuator recesses 102a, 102b of squeeze tabs 84a, 84b, respectively. Actuator recesses 102a, 102b are located below pivot pins 98a, 98b and above spring receivers 104a, 104b, respectively.

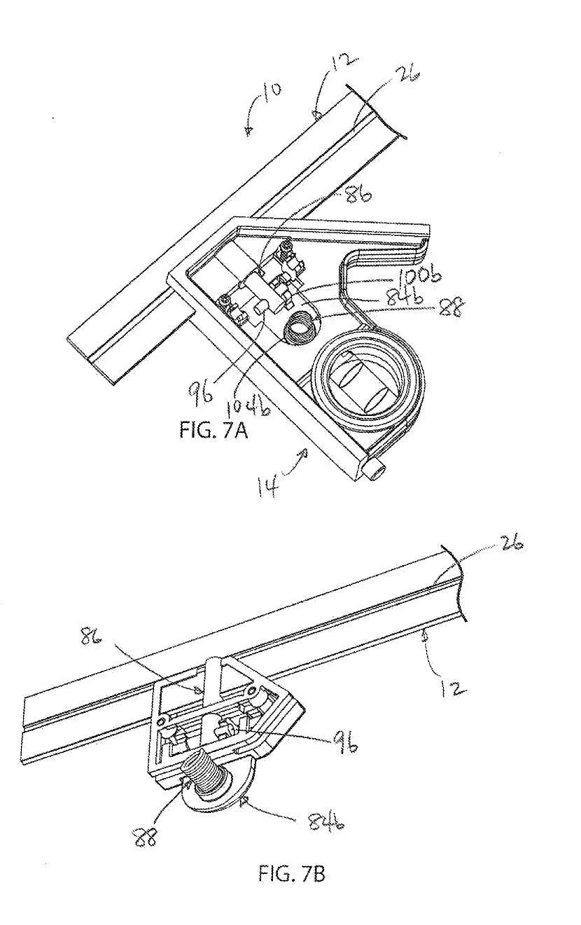

FIG. 7A illustrates adjustable square 10 with cover member 82a and squeeze tab 84a removed. One end of actuator pin 96 is shown as being engaged within actuator recess 100b of squeeze tab 84b. Spring 38 is illustrated as extending from spring receiver 104b of squeeze tab 80 4B. FIG. 7B illustrates portions of the structure of body 14 within which blade 12 is received, showing engagement of engagement tab 94 with groove 26 of blade 12.

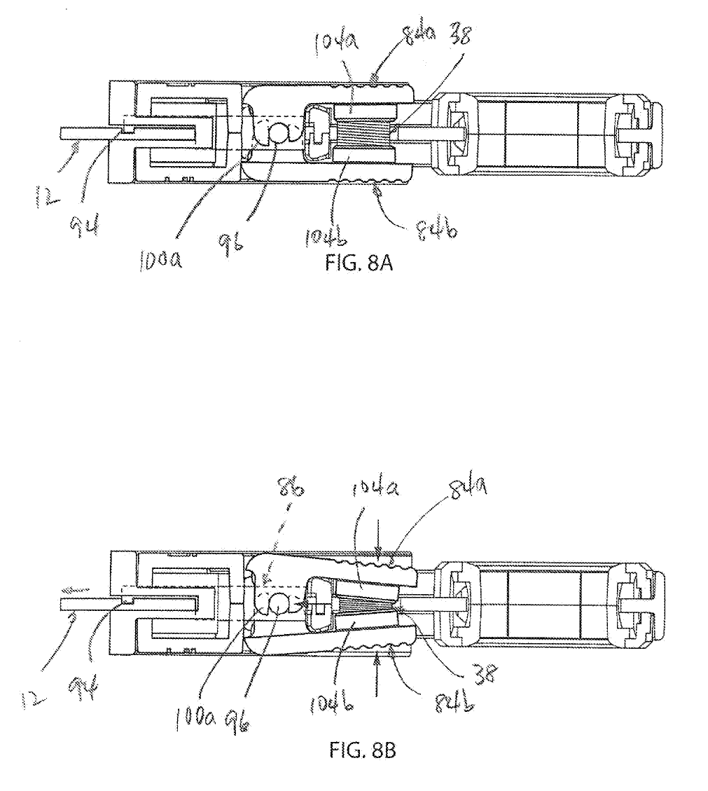

Operation of squeeze-type actuator mechanism 80 is illustrated in FIGS. 8A and 8B. Generally, squeeze tabs 84a and 84b are movable between an engaged, at-rest position as shown in FIG. 8A and a release position as shown in FIG. 8B.

In the engaged, at-rest position as shown in FIG. 8A, spring 38 functions to urge the lower ends of squeeze tabs 84a. 84b apart. Due to the orientation of actuator cradles 100a, 100b below pivot pins 98a, 98b, such outward biased movement of squeeze tabs 84a, 84b functions to draw post 86 downwardly, which results in frictional engagement of the lower edge of blade 12 with the lower surface of slot 24 so as to prevent relative movement between blade 12 and head 14. When it is desired to adjust the position of blade 12 relative to head 14, the user grasps head 14 and applies inward squeezing forces on squeeze tabs 84a, 84b, as shown in FIG. 8B. When the lower ends of squeeze tabs 84a, 84b are moved together in this manner, squeeze tabs 84a, 84b pivot about the parallel pivot axes defined by pivot pins 98a, 98b and spring 38 is compressed. During such movement, actuator cradles 100a and 100b are moved upwardly. Due to engagement of the ends of actuator pin 96 within actuator recesses 102a, 102b, such upward movement of actuator cradles 100a and 100b forces post 86 upwardly. Due to engagement of engagement tab 94 within groove 36 of blade 12, blade 12 is also moved upwardly such that its lower edge is moved out of engagement with the lower surface of slot 24. The user can then slide blade 12 relative to head 14. When the desired position of blade 12 is attained, the user releases the inward squeezing force on squeeze tabs 84a and 84b. Spring 38 returns back to its extended position forcing the lower areas of squeeze tabs 84a and 84b apart and pivoting squeeze tabs 84a and 84b about pivot pins 98a and 98b, respectively. This functions to move actuator cradles 100a, 100b downwardly, returning the lower edge of blade 12 into frictional engagement with the lower surface of slot 24 to prevent axial movement of blade 12 relative to head 14.

It can thus be appreciated that this embodiment of the present invention provides a biased engagement arrangement between the blade and head of an adjustable square, which can be released using a simple, one-handed ergonomically efficient pinching motion to release engagement and to enable adjustment and then return to an engaged position and a biased manner.

While the drawings and the above description show and describe a pair of squeeze tabs that are pinched together to provide the desired actuating movement, it is also contemplated that a single actuator tab may be employed with suitable modifications to the support and biasing arrangement to provide a push tab-type actuation arrangement as opposed to the squeeze-type arrangement as shown and described.

It should be understood that the illustrated embodiments of the present invention are representative of any number of biased engagement arrangements that may be employed in an adjustable square. The invention contemplates any type of normally engaged biased engagement arrangement that can be released using a pivotable actuator or release mechanism and that returns to an engaged position when the actuator or release mechanism is released.

Various alternatives and embodiments are contemplated as being within the scope of the following claims particularly pointing out and distinctly claiming the subject matter regarded as the invention.

We claim:

1. An adjustable square comprising:
a blade extending along a longitudinal axis and having an axially extending engagement structure;
a head having a slot within which the longitudinally extending blade is received, wherein the head includes a movable clamping member engaged with the axially extending engagement structure of the blade;
a biasing member that acts on the movable clamping member so as to bias the clamping member toward an engaged position in which the blade is engaged against a surface of the slot; and
a manually operable pivotable actuator arrangement carried by the head, wherein actuation of the pivotable actuator arrangement applies a force to the clamping member that works against the biasing member so as to selectively move the clamping member away from the engaged position to enable the blade to be moved axially relative to the head, and wherein release of the pivotable actuator arrangement releases the force so that the biasing member returns the clamping member to the engaged position so as to maintain the blade in position relative to the head.

2. The adjustable square of claim 1, wherein the manually operable pivotable actuator arrangement is movable about a pivot axis that is oriented perpendicular to a direction of the force applied by the clamping member on the blade.

3. The adjustable square of claim 1, wherein the manually operable pivotable actuator arrangement is movable about a pivot axis oriented perpendicular to the longitudinal axis of the blade.

4. The adjustable square of claim 1, wherein the manually operable pivotable actuator arrangement is movable about a pivot axis oriented parallel to the longitudinal axis of the blade.

5. The adjustable square of claim 1, wherein the biasing member comprises a spring that acts on the movable clamping member so as to bias the clamping member against the surface of the slot.

6. The adjustable square of claim 1, wherein the manually operable pivotable actuator arrangement comprises a pivotable trigger member secured to the head for movement about a pivot axis generally perpendicular to the longitudinal axis of the blade between an engaged position and a release position, wherein the biasing member is operable to normally bias the pivotable trigger member toward the engaged position, wherein manual actuation of the pivotable trigger member moves the pivotable trigger member to the release position against the force of the biasing member.

7. The adjustable square of claim 6, wherein the pivotable trigger member comprises an actuator section secured to the head via a pivot connection and a finger engagement section that extends from the actuator section, wherein application of a manual force to the finger engagement section causes pivoting movement of the actuator section.

8. The adjustable square of claim 7, wherein the actuator section includes clamping member engagement structure that causes movement of the clamping member away from the engaged position upon pivoting movement of the pivotable trigger member to the release position.

9. The adjustable square of claim 8, wherein the clamping member engagement structure comprises a clamping member connector on the actuator section of the pivotable trigger member.

10. The adjustable square of claim 1, wherein the manually operable pivotable actuator arrangement comprises a pivotable actuator tab secured to the head for movement about a pivot axis generally parallel to the longitudinal axis of the blade between an engaged position and a release position, wherein the biasing member is operable to normally bias the pivotable actuator tab toward the engaged position, wherein manual actuation of the pivotable actuator tab moves the pivotable actuator tab to the release position against the force of the biasing member.

11. The adjustable square of claim 10, wherein the manually operable pivotable actuator arrangement comprises a pair of pivotable actuator tabs that are pivotable about a common pivot axis toward and away from each other between the engaged and disengaged positions.

12. The adjustable square of claim 11, wherein the biasing member comprises a spring interposed between the pair of pivotable actuator tabs, wherein the spring applies a biasing force on the pivotable actuator tabs that urges the pivotable actuator tabs to the engaged position.

13. The adjustable square of claim 10, wherein the pivotable actuator tab comprises an actuator section secured to the head via a pivot connection and a finger engagement section that extends from the actuator section, wherein application of a manual force to the finger engagement section causes linear movement of the actuator section.

14. The adjustable square of claim 13, wherein the actuator section includes clamping member engagement structure that causes linear movement of the clamping member away from the engaged position upon pivoting movement of the pivotable actuator tab to the release position.

15. The adjustable square of claim 14, wherein the clamping member engagement structure comprises a clamping member connector on the actuator section of the pivotable actuator tab.

16. A method of operating an adjustable square that includes a head having a slot within which a longitudinally extending blade is slidably received, comprising the steps of:
normally urging the blade against a surface of the slot via a biasing force to frictionally maintain the blade in position relative to the head;
moving the blade out of engagement with the surface of the slot against the biasing force by manual movement of a manually operable pivotable actuator arrangement to a release position;
adjusting the position of the blade relative to the head while maintaining the manually operable pivotable actuator arrangement in the release position; and
releasing the manually operable pivotable actuator arrangement to enable the blade to engage the surface of the slot under the influence of the biasing force and maintain the blade in position relative to the head.

17. The method of claim 16, wherein the act of normally urging the blade against the surface of the slot is carried out via a movable clamping member engaged with axially extending engagement structure of the blade, and wherein the act of moving the blade out of engagement with the surface of the slot is carried out by moving the movable clamping member by operation of the manually operable pivotable actuator arrangement.

18. The method or claim 17, wherein the act of normally urging the blade the surface of the slot is carried out by application of the biasing force to the clamping member.

19. The method of claim 17, wherein the act of moving the blade out of engagement with the surface of the slot is carried out by manually pivoting the pivotable actuator arrangement about a pivot axis oriented perpendicular to the longitudinal axis of the blade.

20. The method of claim 17, wherein the act of moving the blade out of engagement with the surface of the slot is carried out by manually pivoting the pivotable actuator arrangement about a. Axis oriented parallel to the longitudinal axis of the blade.
